(19) United States
(12) Patent Application Publication
(10) Pub. No.: US 2019/0019127 A1
(43) Pub. Date: Jan. 17, 2019

(54) SMART MEETING SCHEDULER

(71) Applicant: International Business Machines Corporation, Armonk, NY (US)

(72) Inventors: Evelyn R. Anderson, Houston, TX (US); Michael Bender, Rye Brook, NY (US); Rhonda L. Childress, Austin, TX (US); Ea-Ee Jan, Ardsley, NY (US)

(21) Appl. No.: 15/889,405

(22) Filed: Feb. 6, 2018

Related U.S. Application Data
(63) Continuation of application No. 15/650,176, filed on Jul. 14, 2017.

(51) Int. Cl. G06Q 10/06; G06Q 10/10

(52) U.S. Cl. CPC G06Q 10/06312; G06Q 10/1095; G06Q 10/06375; G06Q 10/06; G06Q 10/06314; G06Q 10/109

(57) ABSTRACT

Embodiments of the present invention provide methods, computer program products, and systems for scheduling a meeting. Embodiments of the present invention can be used to calculate a level of criticality and flexibility for each unavailable member of a set of members of a meeting that can be used to prioritize unavailable members of the meeting. Embodiments of the present invention can be used to identify candidate meeting times based, at least in part, on the level of criticality and flexibility for each unavailable member.

### BACKGROUND

The present invention relates generally to the field of scheduling, planning, or task assignment, and more particularly to schedule management.

Organizations increasingly rely on calendar planners that combine and compare calendars of members to schedule team meetings. Typically, a calendar contains a set of time slots. Generally speaking, commitments, appointments, schedules, and meetings are sometimes jointly referred to as “meetings.” “Meeting data” includes, but is not limited to, a date, a time, a duration, a location, a subject of a meeting, a content of a meeting, and/or a set of names corresponding to a set of members. A set of availabilities is a set of time slots that contain no meetings and/or meeting data. A set of meeting data corresponding to a set of members and a set of availabilities corresponding to the set of members are both shared with the set of members. If a member wishes to schedule a meeting with a set of members, the member can use a calendar planner. A calendar planner receives from a member a set of meeting parameters. “Meeting parameters” includes, but is not limited to, a set of names corresponding to a set of members, a meeting time range, a meeting duration, a location, a subject of a meeting, and/or a content of a meeting. A calendar planner checks for a set of time slots, wherein the time slot in the set of time slots is a commonality among a meeting duration, a meeting time range, and a set of availabilities. If a calendar planner finds a set of time slots, a member then chooses a time slot in the set of time slots, schedules the meeting, and shares the meeting data with a set of members.

### SUMMARY

Embodiments of the present invention disclose a method, a computer program product, and a system for scheduling a meeting such that critical members of a meeting are prioritized. In one embodiment of the present invention a method is provided comprising: receiving a set of meeting parameters for a meeting that include a set of members of the meeting, a subject of the meeting, and content for discussion in the meeting; calculating a level of criticality and a level of flexibility for each unavailable member of the set of members of the meeting; combining the level of criticality and the level of flexibility for each unavailable member and mapping the combined level of criticality and the level of flexibility to respective time slots in a set of time slots specified by the meeting parameters; and identifying candidate meeting times based, at least in part, on the combined level of criticality and flexibility for each unavailable member.

### BRIEF DESCRIPTION OF THE DRAWINGS

FIG. 1 is a functional block diagram illustrating a scheduling environment, in accordance with an embodiment of the present invention;

FIG. 2 is a flowchart depicting operational steps of a meeting scheduler program, on a server computer within the scheduling environment of FIG. 1, for scheduling a meeting, in accordance with an embodiment of the present invention;

FIG. 3 is a flowchart depicting operational steps of a criticality score process, on a server computer within the scheduling environment of FIG. 1, for determining a criticality score, in accordance with an embodiment of the present invention; and

FIG. 4 depicts a block diagram of components of the server computer executing the intelligent mapping program within the distributed data processing environment of FIG. 1, in accordance with an embodiment of the present invention.

### DETAILED DESCRIPTION

Embodiments of the present invention recognize that there is difficulty scheduling a meeting. In some instances, there can be a meeting requiring three different members: person A, person B, and person C. A meeting scheduler might be able to schedule person B and C, but fail to identify that person A is the most critical member to a meeting. As such, the meeting scheduler fails to schedule person A because the scheduler prioritized having the most available members to be scheduled at any given time. Alternatively, some meeting schedulers use a rank of a participant in an organization in determining importance or criticality of the participant for a meeting (e.g. a CEO of a company is given highest priority in participation), but this leads to a static ranking system for determining a meeting over time. Furthermore, high-ranking participants may not be necessary for the meeting where such a ranking system could skew or prevent the scheduling of a meeting when really the high-ranking participant may only intend to witness the meeting. Embodiments of the present invention provide solutions for scheduling a meeting such that critical members are prioritized based, at least in part, upon participant involvement in prior meetings and emails on a subject. In this manner, as described in greater detail later in the specification, embodiments of the present invention can be used to generate a critical score that can be used to prioritize critical members of a meeting.

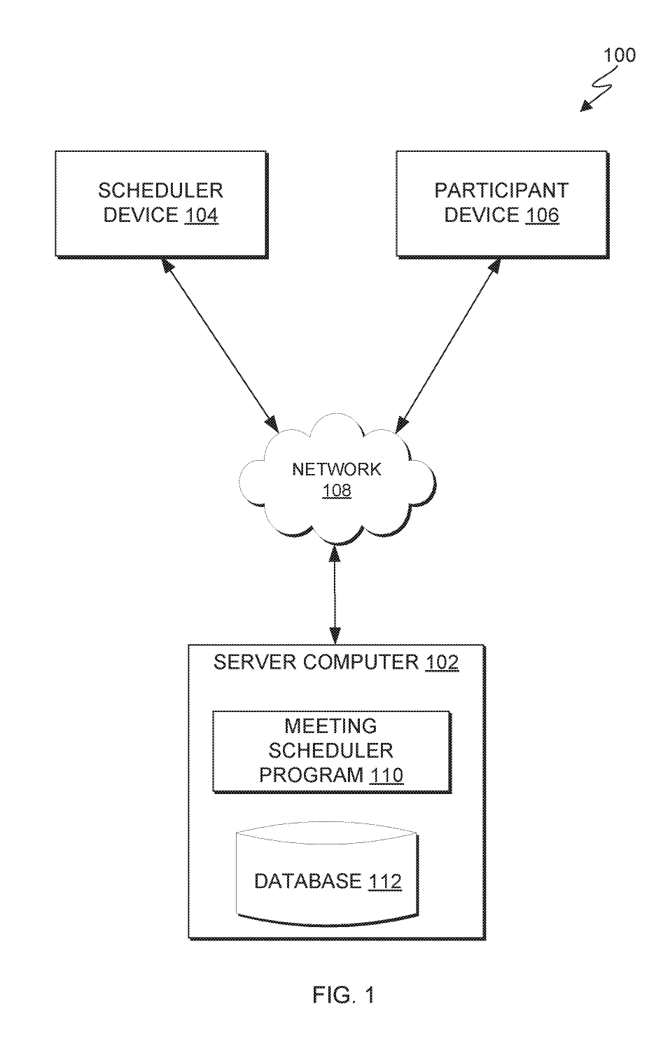

The present invention will now be described in detail with reference to the Figures. FIG. 1 is a functional block diagram illustrating a scheduling environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Scheduling environment 100 includes server computer 102, scheduler device 104, and participant device 106, all interconnected over network 108. Network 108 can be, for example, a telecommunications network, a local area network (LAN), a wide area network (WAN), such as the Internet, or a combination of the three, and can include wired, wireless, or fiber optic connections. Network 108 can include one or more wired and/or wireless networks that are capable of receiving and transmitting data, voice, and/or video signals, including multimedia signals that include voice, data, and video information. In general, network 108 can be any combination of connections and protocols that will support communications among server computer 102, scheduler device 104, participant device 106, and other computing devices (not shown) within scheduling environment 100.

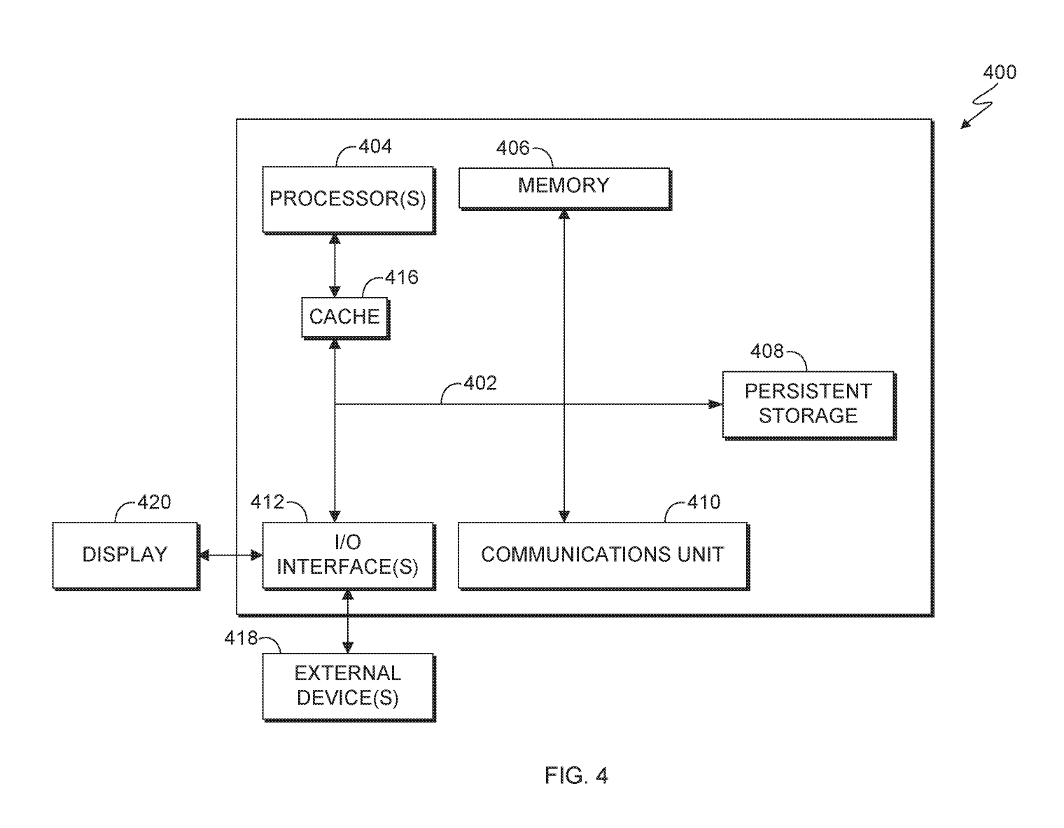

Scheduler device 104 and participant device 106 can each be a laptop computer, a tablet computer, a smart phone, other mobile computing device, wearable computing device, or any programmable electronic device capable of communicating with various components and devices within scheduling environment 100, via network 108. In general, scheduler device 104 and participant device 106 each represent any programmable electronic device or combination of programmable electronic devices capable of executing machine readable program instructions and communicating with other computing devices (not shown) within scheduling environment 100 via a network, such as network 108. Scheduler device 104 and participant device 106 may include internal and external hardware components, as depicted and described in further detail with respect to FIG. 4.

Server computer 102 can be a standalone computing device, a management server, a web server, a mobile computing device, or any other electronic device or computing system capable of receiving, sending, and processing data. In other embodiments, server computer 102 can represent a server computing system utilizing multiple computers as a server system, such as in a cloud computing environment. In another embodiment, server computer 102 can be a laptop computer, a tablet computer, a netbook computer, a personal computer (PC), a desktop computer, a personal digital assistant (PDA), a smart phone, or any other programmable electronic device capable of communicating with scheduler device 104, participant device 106, and other computing devices (not shown) within scheduling environment 100 via network 108. In another embodiment, server computer 102 represents a computing system utilizing clustered computers and components (e.g., database server computers, application server computers, etc.) that act as a single pool of seamless resources when accessed within scheduling environment 100.

In other embodiments, server computer 102 and scheduler device 104 are a single device. In other embodiments, server computer 102 and participant device 106 are a single device. In other embodiments, server computer 102, scheduler device 104, and participant device 106 are a single device. Server computer 102 includes meeting scheduler program 110 and database 112. Server computer 102 may include internal and external hardware components, as depicted and described in further detail with respect to FIG. 4.

Meeting scheduler program 110 optimizes member attendance for meetings and can recommend a list of email recipients based at least in part on a calculated criticality score for members or email recipients. A “criticality score”, as used herein, refers to a numerical value that is used to identify a level of criticality (i.e., level of importance) for members of a meeting or an email. A member who is “critical” to a meeting can be a member whose presence is required for a meeting or email, a member that needs to participate, or is otherwise a member responsible for having the meeting. A “member” as used herein, refers to an entity associated with a meeting. For example, a member can be a participant of a meeting, a scheduler of a meeting, or an attendee of a meeting. As used herein, a member cannot be a participant and a scheduler simultaneously. As used herein, a participant, scheduler, or attendee can be referred to as a member. A “scheduler” used herein, refers to a member that is a host, chairman, or leader of a meeting. If a meeting is scheduled through a proxy scheduler, such as an assistant or secretary of a host of a meeting, meeting scheduler program 110 receives from a proxy scheduler a designation identifying the host as a scheduler of the meeting.

In this embodiment, meeting scheduler program 110 calculates a criticality score by compiling, for a member, a set of time slots for scheduling a meeting for when there are no time slots commonly available among a set of members. Meeting scheduler program 110 can then receive a set of meeting parameters from a member. Meeting scheduler program 110 receives a request from a member to find a commonality among a meeting duration, a meeting time range, and a set of availabilities among a set of members. A “commonality” as used herein, refers to a time slot that is commonly available in a set of availabilities corresponding to a set of members, is a time slot that is within a meeting time range as laid out in a set of meeting parameters, and is a time slot that is at least equal to a meeting duration as laid out in the set of meeting parameters.

Meeting scheduler program 110 can then acquire a set of availabilities corresponding to a set of members. In some embodiments, meeting scheduler program 110 acquires a set of availabilities from database 112. In other embodiments, meeting scheduler program 110 acquires a set of meeting data from database 112, then meeting scheduler program 110 determines a set of availabilities from the set of meeting data. Meeting scheduler program 110 can then check for a set of time slots, wherein the time slot in the set of time slots is a commonality among a meeting duration, a meeting time range, and a set of availabilities.

Meeting scheduler program 110 can then determine a commonality is a null set among a meeting duration, a meeting time range, and a set of availabilities. In this embodiment, a “null set” is a set of time slots wherein the number of time slots is zero. For example, if person A, person B, and person C are attempting to schedule a meeting within a meeting time range, yet there are no time slots within the meeting time range such that person A, person B, and person C can schedule a meeting without a scheduling conflict, then there are zero number of time slots (i.e. null set) that are a commonality among a set of availabilities of person A, person B, and person C.

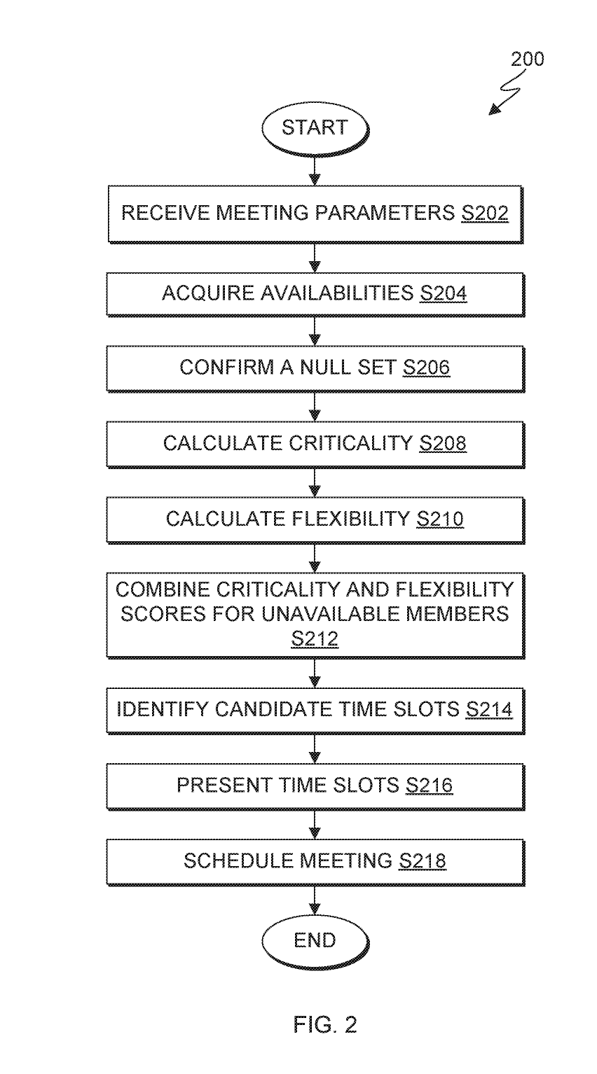

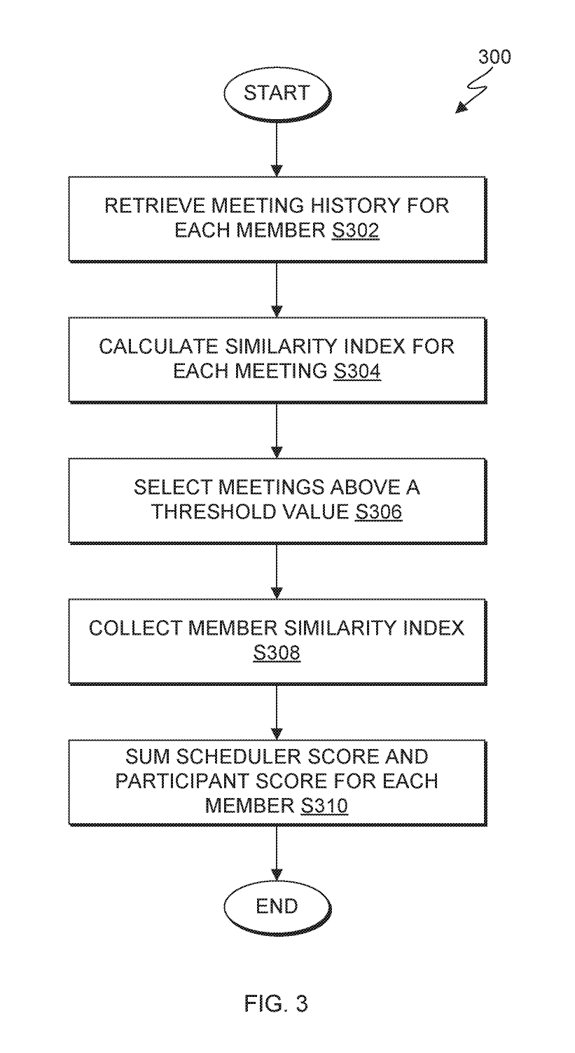

Meeting scheduler program 110 can then determine a set of unavailable members corresponding to a set of time slots. Meeting scheduler program 110 can then calculate a criticality score for each unavailable member based, at least in part on, on meeting parameters and set of received meeting history, as described in greater detail in FIGS. 2 and 3. Meeting scheduler program 110 compiles and presents to a member a ranked list of time slots in an order that minimizes the set of unavailable members that are critical to a meeting. Meeting scheduler program 110 is depicted and described in further detail with respect to FIG. 2.

Database 112 is a repository for data used by meeting scheduler program 110. Database 112 can be implemented with any type of storage device capable of storing data and configuration files that can be accessed and utilized by server computer 102, such as a database server, a hard disk drive, or a flash memory. Database 112 stores a set of meeting data corresponding to a set of members. “Meeting data”, as used herein, is defined as a set of data corresponding to a meeting. In this example, a “meeting” refers to an assembly of people that takes place in the future relative to the moment of executing meeting scheduler program 110. In other words, “meeting data” corresponds to data of a meeting that is scheduled, but has not yet occurred. “Meeting data” includes, but is not limited to, a date, a time, a duration, a location, a subject of a meeting, a content of a meeting, and/or a set of names corresponding to a set of members. Database 112 can also store a set of meeting history of past meetings associated with a set of members that participated in those past meetings. “Meeting history”, as used herein, is defined as a set of data corresponding to a meeting that has already occurred. “Meeting history” includes, but is not limited to, a date, a time, a duration, a location, a subject of a meeting, a content of a meeting, and/or a set of names corresponding to a set of members. In an alternate embodiment, database 112 stores a set of availabilities corresponding to a set of members. Database 112 stores a set of email history corresponding to a set of members. “Email history” includes, but is not limited to, an email subject, an email content, a set of names corresponding to a set of email recipients, and/or a name of an email sender. “Email history”, as used herein, is defined as a set of data corresponding to an email or message that was sent or received in the past relative to the moment of executing meeting scheduler program 110.

FIG. 2 is flowchart 200 depicting operational steps of meeting scheduler program 110, on server computer 102 within scheduling environment 100 of FIG. 1, for scheduling a meeting for a set of members for when there are no time slots commonly available among a set of members, in accordance with an embodiment of the present invention.

Meeting scheduler program 110 receives a set of meeting parameters (S202). In this embodiment, meeting scheduler program 110 receives a set of meeting parameters via scheduler device 104 from a scheduler. In one embodiment, meeting scheduler program 110 receives, via database 112, a set of meeting parameters for a meeting that recurs over a set period of time. For example, a scheduler may set meeting scheduler program 110 to execute with a weekly period with a time range spanning over the course of a week. Meeting scheduler program 110 can then retrieve the meeting parameters weekly from database 112 to determine for a scheduler a set of time slots within the time range. In another embodiment, meeting scheduler program 110 receives a first subset of the set of meeting parameters via scheduler device 104 and a second subset of the set of meeting parameters via database 112. For example, if a meeting with a set of meeting parameters had occurred in the past and was recorded on database 112 as a set of meeting history, meeting scheduler program 110 may receive only a meeting subject as a first subset of a set of meeting parameters, and acquires a second subset of the meeting parameters, via database 112, by acquiring a set of meeting parameters from a set of meeting history that are similar to the meeting.

Meeting scheduler program 110 acquires a set of availabilities corresponding to a set of members (S204). Meeting scheduler program 110 acquires a set of availabilities corresponding to a set of members that are listed in a set of meeting parameters received in operation S202. In this embodiment, meeting scheduler program 110 acquires a set of availabilities from database 112. In an alternative embodiment, meeting scheduler program 110 acquires a set of meeting data from database 112. meeting scheduler program 110 can then extrapolate a set of availabilities from the set of meeting data. In another embodiment, meeting scheduler program 110 acquires a set of meeting data from social media platforms of the set of members. In one embodiment, meeting scheduler program 110 receives a set of meeting data from scheduler device 104. In another embodiment, meeting scheduler program 110 receives a set of meeting data from participant device 106. In one embodiment, meeting scheduler program 110 receives a set of meeting data from scheduler device 104 and participant device 106.

Meeting scheduler program 110 confirms a null set (S206). Meeting scheduler program 110 checks if a commonality is a null set among a meeting duration (obtained from operation S202), a meeting time range (obtained from operation S202), and a set of availabilities (obtained from operation S204). For example, in this embodiment, meeting scheduler program 110 checks for a set of time slots that are commonly available among a set of availabilities that correspond to a set of members. If meeting scheduler program 110 determines that there are no time slots commonly available among a set of availabilities that correspond to a set of members, then the commonality is a null set, regardless of a set of meeting parameters. If meeting scheduler program 110 determines there is a set of time slots commonly available among a set of availabilities corresponding to a set of members, but the set of time slots commonly available have a set of durations less than a meeting duration as laid out by a set of meeting parameters, then the commonality is a null set.

Meeting scheduler program 110 calculates a set of criticality scores corresponding to a set of members (S208). A criticality score is a numerical representation that quantifies the criticality of a member for a meeting with regards to a relation of a member to a subject or discussion. In this embodiment, numerical values are used where lower numbers represent a lesser degree of importance, whereas higher numbers represent a higher degree of importance. In other embodiments, any numerical representation may be used. In this embodiment, meeting scheduler program 110 calculates a set of criticality scores by utilizing a set of meeting parameters and a set of meeting history to calculate a set of similarity indices and summing the set of similarity indices as described in greater detail with regard to FIG. 3, flowchart 300.

In another embodiment, a set of criticality scores can be used for recommending email recipients for a message. In this embodiment, meeting scheduler program 110 calculates a set of criticality scores by utilizing an unsent email and a set of email history to assign a set of similarity indices corresponding to the set of email history. Meeting scheduler program 110 sums the set of similarity indices to become a set of criticality scores corresponding to a set of persons, wherein the set of persons are associated with the set of email history as either a sender or a receiver. Meeting scheduler program 110 selects a set of persons which have a set of criticality scores above an email criticality threshold. If the selected set of persons are not listed as recipients of the unsent email, meeting scheduler program 110 recommends the selected set of persons as a recipient of the unsent email.

For example, after a user has finished composing an email and is preparing to select a set of recipients to receive the email, meeting scheduler program 110 receives a notification from a user via scheduler device 104 to calculate a set of recommended recipients to receive the email. In a further embodiment, meeting scheduler program 110 receives a chosen set of recipients by the user. Meeting scheduler program 110 acquires the email, a set of email history of the user, and in a further embodiment, a set of email history corresponding to the chosen set of recipients. The combined set of email history corresponding to the user and the chosen set of recipients can be collectively called a set of “email history”.

Continuing the above discussion with regard to calculating a criticality score for emails, meeting scheduler program 110 can then calculate a set of similarity indices corresponding to the set of email history. Meeting scheduler program 110 calculates a similarity index using a weighted sum of a similarity calculation between a) the email subject and an email subject from the set of email history, and b) the email content and the email content from the set of email history, wherein the similarity calculation can be, but not limited to, a cosine distance calculation or a Kullback-Leibler divergence calculation. Meeting scheduler program 110 extracts a set of email recipients from a set of email history that have a similarity index above an email similarity threshold, wherein the email similarity threshold is a numerical value received by a user. Meeting scheduler program 110 acquires a set of email history corresponding to the extracted set of email recipients, and likewise calculates a set of similarity indices between the email and the email history of the extracted set of email recipients.

Meeting scheduler program 110 can then sum a set of similarity scores for sent emails and a set of similarity scores for received emails, both for each person. Meeting scheduler program 110 calculates for each person a weighted sum of the summed similarity score for sent emails and the summed similarity score for received emails. Meeting scheduler program 110 can then select a set of persons which have a set of criticality scores above an email criticality threshold. Accordingly, meeting scheduler program 110 recommends the selected set of persons as a recipient of the email. For example, where a person of the selected set of persons is not included in a set of recipients for an email, meeting scheduler program 110 can recommend the person from selected set of persons as recommendations to the user for another recipient of the email. In a further embodiment, meeting scheduler program 110 calculates a criticality scores for recommending email recipients for a message by utilizing a set of email history and a set of meeting history.

Meeting scheduler program 110 calculates a set of flexibility scores corresponding to a set of members (S210). A flexibility score is a numerical representation that quantifies a level of flexibility a member has when determining whether to abandon other conflicting meetings or obligations in order to attend a meeting, wherein higher flexibility scores means a member is less critical to a conflicting meeting and is more willing to abandon the conflicting meeting, and a lower flexibility scores means a member is critical to a conflicting meeting and is unable to abandon the meeting. Meeting scheduler program 110 calculates a criticality score for a member corresponding to a conflicting meeting that is occupying a time slot. Meeting scheduler program 110 calculates a flexibility score for a member by inputting the criticality score of a conflicting into a flexibility algorithm, wherein the result acts as an anti-criticality score for a meeting in a conflicting time slot. For example, meeting scheduler program 110 is determining an optimal time slot for two people (person A and person B) for a meeting (meeting T). At time slot 1, person A has a conflict with meeting X, and person B has a conflict with meeting Y. Assuming criticality scores range from 0 to 1 (0 being not critical to a meeting, and 1 being highly critical to a meeting), meeting scheduler program 110 determines person A is highly critical for meeting X (e.g. person A for meeting X has a criticality score of 0.97), and determines person B is less critical for meeting Y (e.g. person B for meeting Y has a criticality score of 0.2). In one embodiment, meeting scheduler program 110 calculates the flexibility score by the, but not limited to, the formula reproduced below:

F=Cₘₐₓ−C Formula 1

wherein F is the flexibility score, C_{Max} is the maximum possible criticality score, and C is the criticality score between a member and a conflicting meeting in a timeslot. Following through the example noted above, C_{Max}=1, since the assumed criticality score ranges from 0 to 1 with 1 being the maximum value. For person A, the criticality score for meeting X is C=0.97, thus meeting scheduler program 110 calculates the flexibility score for person A for meeting T to be 1−0.97=0.03; meaning, person A has low flexibility in abandoning meeting X for meeting T. Likewise, the criticality score for person B for meeting Y is C=0.2, thus meeting scheduler program 110 calculates the flexibility score for person B for meeting T to be 1−0.2=0.8; meaning, person B has a high flexibility in abandoning meeting Y for meeting T.

In alternative embodiment, meeting scheduler program 110 calculates the flexibility score by the, but not limited to, the formula reproduced below:

$$F = \frac{k}{C} \qquad Formula 2$$

wherein F is the flexibility score, k is a constant determined by a scheduler, and C is the criticality score between a member and a conflicting meeting in a timeslot.

Meeting scheduler program 110 combines a set of criticality scores and a set of flexibility scores for a set of unavailable members (S212). In this embodiment, for each time slot within a meeting time range, meeting scheduler program 110 takes the difference in the sum of a set of criticality scores and a sum of a set of flexibility scores, both corresponding to a set of unavailable members for the time slot, by mapping both the set of criticality scores and the set of flexibility scores to each time slot, and then finding the difference of the two sums such that each time slot has a resulting value called an unavailability score.

In this embodiment, meeting scheduler program 110 uses a weighted difference of the summed criticality score and summed flexibility score for a set of unavailable members for each time slot. The weighted sum of the criticality and flexibility score for each time slot is referred to as an unavailability score. In this embodiment, meeting scheduler program 110 calculates an unavailability score using the formula reproduced below:

$${W}_{c} * \sum C - {W}_{f} \sum F = U \qquad Formula 3$$

where W_{c} and W_{f} are score weights for the summed criticality and summed flexibility respectively, ΣC and ΣF are the respective summed criticality and summed flexibility scores, and U is the unavailability score for a time slot.

In further embodiments, meeting scheduler program 110 can select a set of time slots in any convenient manner other than what is defined by the set of meeting parameters. For example, 110 can divide time slots into increments of one of, but is not limited to, the following: (i) days; (ii) hours; (iii) 30 minutes; (iv) 15 minutes; (v) 5 minutes; or (vi) 1 minute.

In another embodiment, meeting scheduler program 110 determines a set of members as a delegated group, and reduces the set of criticality scores of the delegated group. The set of members in a delegated group are such that a single member of the delegated group may be enough for a meeting. In this embodiment, meeting scheduler program 110 determines a set of members that have similar recipients for a set of email history or similar members for a set of meeting history by checking for a set of members with similar similarity scores for a set of email history and set of meeting history. If meeting scheduler program 110 finds a set of members of similarity scores for a set of email or a set of meeting history, meeting scheduler program 110 prompts a scheduler requesting information to determine whether the set of members is a delegated group. If meeting scheduler program 110 receives confirmation that a set of members are a delegated group, meeting scheduler program 110 reduces a set of criticality scores corresponding to the delegated group by a factor determined by a scheduler. For example, if person A and person B are designated as a delegated group and a scheduler designates a delegated group reduction factor to be 80%, meeting scheduler program 110 reduces the criticality score of both person A and person B by a factor of 80%.

Meeting scheduler program 110 identifies a set of candidate time slots (S214). In this embodiment, meeting scheduler program 110 identifies a set of candidate time slots by sorting a set of time slots based on a set of unavailability scores that correspond to the set of time slots. For example, where a numerical score is used, a higher number unavailability score corresponds to greater loss of critical members for a meeting, then meeting scheduler program 110 sorts time slots in a numerically increasing order, based upon the unavailability score, such that the first listed time slot is the time slot that would minimize the loss of critical members better than the next listed time slot.

In another embodiment, meeting scheduler program 110 identifies candidate meeting times based on a set of meeting history. As stated previously, “meeting history”, as used herein, refers to a set of meeting data containing a set of meetings that have occurred in the past prior to scheduling a meeting. For example, if meeting scheduler program 110 determines from a set of meeting history that meetings similar to a set of meeting parameters are held on Wednesdays, and are weekly meetings, then meeting scheduler program 110 will designate the following Wednesday as a recommended time slot, wherein a designation of a recommended time slot can be indicated via highlighting or color coding, a symbolic marking (e.g. a star or a flag), or a notification window listing a set of recommended time slots.

In an alternative embodiment, meeting scheduler program 110 identifies candidate meeting times based upon a set of meeting history, wherein meeting scheduler program 110 uses, but is not limited to, a linear fit to the time separation between similar meetings in the set of meeting history. In this embodiment, meeting scheduler program 110 applies a linear fit in determining a pattern in chosen time slots of similar meetings in set of meeting history, and presents for a scheduler a set of time slots that follow the linear fit. For example, meeting scheduler program 110 determines, for a set of meeting parameters, that a set of similar meetings above a threshold value have a time separation of 7 days between meeting 1 and meeting 2, 7 days between meeting 2 and meeting 3, and 7 days between meeting 3 and meeting 4, that a linear fit in time separation is 7 days. Meeting scheduler program 110 determines that the linear fit time separation is 7 days, and presents a time slot that is 7 days in separation from the most recent similar meeting. In a further embodiment, meeting scheduler program 110 can use a low pass filter that filters away less frequent trends in meeting time separations. For example, if the time separation in meetings is a series 7, 7, 7, 2, 8, 7, 15, 7; then meeting scheduler program 110 finds that the trending separation is 7 by using a low pass filter, which removes the anomalous separations of 2 and 15.

Meeting scheduler program 110 presents a set of time slots to the scheduler (S216). In this embodiment, meeting scheduler program 110 presents a set of candidate time slots via scheduler device 104. In a further embodiment, meeting scheduler program 110 can display a set of recommended time slots along with a set of candidate time slots. Accordingly, a user may select a presented time slot or choose to manually schedule a different time slot.

Meeting scheduler program 110 schedules the meeting based on the user selection (S218). Meeting scheduler program 110 records a time slot selection as meeting data in database 112 associated with a set of members of the meeting. Meeting scheduler program 110 can then share the scheduled meeting with a set of calendars associated with members of the scheduled meeting and store the scheduled meeting as part of meeting data in database 112. In this embodiment, meeting scheduler program 110 records a time slot selected by the user as a scheduler preference for future reference after meeting scheduler program 110 schedules the meeting, wherein a future reference may include, but not limited to, operations S204, S214, and S302. For example, meeting scheduler program 110 receives a time slot selection from a scheduler and records the time slot selection in database 112. In other embodiments, meeting scheduler program 110 can record and store a time slot selected by the user in one or more other components of scheduling environment 100.

FIG. 3 is flowchart 300 depicting operational steps of calculating a set of criticality scores, on server computer 102 within scheduling environment 100 of FIG. 1 in accordance with an embodiment of the present invention.

Meeting scheduler program 110 retrieves a set of meeting history corresponding to a set of members (S302). In this embodiment, meeting scheduler program 110 retrieves a set of meeting history by accessing database 112, that corresponds to a set of members listed in the received meeting parameters. In other embodiments, meeting scheduler program 110 can retrieve a set of meeting history from one or more other components of scheduling environment 100. In a further embodiment, meeting scheduler program 110 retrieves a set of email history for each member.

Meeting scheduler program 110 calculates a set of similarity indices corresponding to a set of meeting history (S304). In this embodiment, meeting scheduler program 110 calculates a set of similarity indices between a set of meeting parameters and a set of meeting history using, but not limited to, a weighted sum of a cosine distance calculation. In this embodiment, the similarity calculation is performed between 1) a subject defined by the set of meeting parameters and a subject defined by the set of meeting history, and 2) a set of content defined by the set of meeting parameters and a set of content defined by the set of meeting history.

For example, a subject defined by a set of meeting parameters and a subject of a meeting in a set of meeting history can both be represented as N-dimension vectors \vec{u} and \vec{v} respectively, wherein each dimension of the vector corresponds to a unique word listed for both subjects combined. For example, given the subject of the meeting parameters be “Disk space issue and business opportunity discussion”, and the subject of a meeting of the set of meeting history be “Disk usage opportunity”. Meeting scheduler program 110 compiles a list of unique words of both subjects. For example, the list could include: “disk, space, issue, and, business, opportunity, discussion, usage”, which gives an eight-dimensional space for both subject vectors to reside. Meeting scheduler program 110 generates the subject vector, defined by the set of meeting parameters as:

\vec{u}=[1, 1, 1, 1, 1, 1, 1, 0] Example vector 1

as the subject vector defined by the set of meeting parameters \vec{u} contains all the unique words except for “usage”. The subject vector of the meeting in a set of meeting history becomes:

\vec{v}=[1, 0, 0, 0, 0,1, 0,1] Example vector 2

as this subject vector of the meeting in the set of meeting history \vec{v} contains only “disk”, “opportunity”, and “usage”.

Meeting scheduler program 110 calculates a similarity score using a cosine distance between the subjects is calculated using the formula reproduced below:

$${S}_{sub} = cos ( \vec{u} , \vec{v} ) = \frac{\vec{u} \cdot \vec{v}}{\vert \vec{u} \vert \vert \vec{v} \vert} = \frac{{\sum }_{i = 1}^{8} {u}_{i} * {v}_{i}}{\sqrt{{\sum }_{i = 1}^{8} {u}_{i}^{2}} \sqrt{{\sum }_{i = 1}^{8} {v}_{i}^{2}}} = \frac{2}{\sqrt{6} \sqrt{3}} ≅ 0.47 \qquad Formula 4$$

wherein S_{sub} is the similarity score between subjects. The similarity score between content of the meeting parameters and the content of the meeting of the set of meeting history is calculated in the same fashion by constructing vectors to represent the contents, and calculating the similarity score between them through a cosine distance. In an alternative embodiment, the similarity calculation can also be performed by using an Kullback-Leibler divergence.

Meeting scheduler program 110 calculates a similarity index for a meeting in a set of meeting history by combining the similarity score of the subject and the similarity score of the content by using a weighted sum, wherein the sum weights are determined by a scheduler. For example, meeting scheduler program 110 calculates a similarity index by the formula reproduced below:

$$I = {W}_{Sub} * {S}_{Sub} + {W}_{Con} * {S}_{Con} \qquad Formula 5$$

Wherein 1 is the similarity index assigned to a meeting in a set of meeting history, W_{S} and W_{C} are the respective score weights for subject and content, and S_{Sub} and S_{Con} are the respective similarity scores for subject and content between a set of meeting parameters and a meeting in a set of meeting history.

In a further embodiment, meeting scheduler program 110 performs a similarity calculation between a subject and a set of content defined by a set of meeting parameters and a subject and asset of content defined by an email in a set of email history. In this embodiment, an email in a set of email history is assigned a similarity index as calculated in formula 5.

In a further embodiment, meeting scheduler program 110 calculates a similarity index by incorporating an exponential time decay. In this embodiment, a meeting in a set of meeting history that occurred in the distant past is regarded as less relevant to a set of meeting parameters than a meeting in a set of meeting history that occurred in the recent past. For example, for a meeting in a set of meeting history, meeting scheduler program 110 calculates a similarity index with an exponential time decay by the formula reproduced below:

$$I = {I}_{0} * {e}^{a - b * t} \qquad Formula 6$$

wherein s is a similarity index with incorporated exponential time decay, I₀ is a similarity index (e.g. a standalone similarity index calculation such as a weighted cosine distance), a is a normalizing constant, b is an exponential decay constant, and t is a quantity of time measured between the date meeting scheduling program 110 is executed and the date of a meeting in a set of meeting history. Meeting scheduler program 110 can have exponential scaling constant a and exponential decay constant b as a default value. Meeting scheduler program 110 can receive, from a member, values defining normalizing constant a and exponential decay constant b. Quantity of time t is the amount of time passed between the date the similarity calculation is performed and the date a prior meeting occurred as determined by a set of meeting history. Quantity of time t can be quantity of units of, but is not limited to, the following: (i) days; (ii) hours; (iii) 30 minutes; (iv) 15 minutes; (v) 5 minutes; or (vi) 1 minute.

Meeting scheduler program 110 selects a set of meeting history that have similarity indices that exceed an index threshold determined by a scheduler (S306). In a further embodiment, if meeting scheduler program 110 determines from the selected set of meeting history that there is a set of associate members whom are listed as a member of a meeting, then meeting scheduler program 110 repeats operations S302 through S306 for the set of associate members by acquiring a set of unique meeting history corresponding to the set of associate members, calculating a set of similarity indices corresponding to the set of unique meeting history, and joins the set of unique meeting history having similarity indices that exceed an index threshold along with the selected set of meeting history to become a selected set of meeting history. An associate member is a member whom meeting scheduler program 110 has not yet retrieved a set of meeting history, but is a member listed in the set of selected meeting history. A set of unique meeting history is a set of meeting history corresponding to a set of associate members that meeting scheduler program 110 has not yet calculated a corresponding similarity index. Meeting scheduler program 110 repeats S302 through S306 for the set of associate members until meeting scheduler program 110 determines either a) there are no longer a set of associate members in the selected set of meeting history, or b) the number of unique members listed in the selected set of meeting history reaches a unique member threshold determined by a scheduler. In a further embodiment, operation S306 is performed using a set of email history.

Meeting scheduler program 110 collects a set of similarity indices for a set of members (S308). Meeting scheduler program 110 uses the selected set of meeting history determined from operation S306 to compile a member meeting participation list. In this embodiment, meeting scheduler program 110 compiles a member meeting list by identifying a set of unique members listed in the selected set of meeting history, compiles a list of meetings corresponding to each member where the member was either a scheduler or a participant, identifies the role of the member as a scheduler or a participant, sums the similarity indices corresponding to the set of meetings that the member was a participant, and sums the similarity indices corresponding to the set of meetings that the member was a scheduler. This operation results in meeting scheduler program 110 compiling a member meeting participation list that contains a set of unique members, a participant score corresponding to each member, wherein a “participant score” is a summed similarity index for a set of meetings the unique member was a participant; and a scheduler score corresponding to each member, wherein a “scheduler score” is a summed similarity index for a set of meetings the unique member was a scheduler.

For example, for a single member, meeting scheduler program 110 calculates a scheduler score by the formula reproduced below:

$$S = {I}_{1} + {I}_{2} + {I}_{3} \qquad Formula 7$$

wherein S is the scheduler score, and I₁, I₂, and I₃ are similarity indices for meetings where the member was a scheduler. Likewise, for the single member, meeting scheduler program 110 calculates a participant score by the formula reproduced below:

$$P = {I}_{4} + {I}_{5} + {I}_{6} \qquad Formula 8$$

wherein P is the scheduler score, and I₄, I₅, and I₆ are similarity indices for meetings where the member was a participant.

In a further embodiment, meeting scheduler program 110 compiles a member meeting list by identifying a set of unique members listed in the selected set of meeting history, compiles a list of meetings corresponding to each member where the member was either a scheduler, a primary participant, a secondary participant (e.g. members invited to a meeting that are deemed non-critical to a meeting, but can attend nonetheless. This is comparable to a carbon copy (C.C.) for a meeting invite), or an auxiliary participant (e.g. members that are only informed of the occurrence of a meeting and are deemed non-critical to the meeting. This is comparable to a blind carbon copy (B.C.C.) for a meeting invite), identifies the role of the member as a scheduler or a participant, sums the similarity indices corresponding to the set of meetings that the member was a scheduler, sums the similarity indices corresponding to the set of meetings that the member was a primary participant, sums the similarity indices corresponding to the set of meetings that the member was a secondary participant, and sums the similarity indices corresponding to the set of meetings that the member was an auxiliary participant.

In another embodiment, meeting scheduler program 110 performs operation S308 for a set of email history. Meeting scheduler program uses the selected set of email history determined from operation S306 to compile a member email list. In this embodiment, meeting scheduler program 110 compiles a list of emails corresponding to each member where the member was either a sender or a receiver of an email in a set of email history, identifies the role of the member as a sender or a receiver, sums the similarity indices corresponding to the set of emails that the member was a sender, and sums the similarity indices corresponding to the set of emails that the member was a receiver. In this embodiment, this operation results in meeting scheduler program 110 compiling a member email list that contains a set of unique members, a sender score corresponding to each member, wherein a “sender score” is a summed similarity index for a set of emails the unique member was a sender; and a receiver score corresponding to each member, wherein a “receiver score” is a summed similarity index for a set of emails the unique member was a receiver.

For example, for a single member, meeting scheduler program 110 calculates a sender score by the formula reproduced below:

$$Send = {I}_{1} + {I}_{2} + {I}_{3} \qquad Formula 9$$

wherein Send is the sender score, and I₁, I₂, and I₃ are similarity indices for emails where the member was a sender. Likewise, for the single member, meeting scheduler program 110 calculates a receiver score by the formula reproduced below:

$$Rec = {I}_{4} + {I}_{5} + {I}_{6} \qquad Formula 10$$

wherein Rec is the receiver score, and I₄, I₅, and I₆ are similarity indices for emails where the member was a receiver.

In a further embodiment, meeting scheduler program 110 compiles a list of emails corresponding to each member where the member was either a sender, a primary receiver (e.g. a member of a message that the message is primarily addressing), a secondary receiver (e.g. a member of a message designated as a carbon copy recipient, or as more commonly known as “C.C.” recipients), or an auxiliary receiver (e.g. a member of a message designated as a blind carbon copy recipient, or as more commonly known as “B.C.C.”) of an email in a set of email history, identifies the role of the member as a sender, a primary receiver, a secondary receiver, or an auxiliary receiver; sums the similarity indices corresponding to the set of emails that the member was a sender, sums the similarity indices corresponding to the set of emails that the member was a primary receiver, sums the similarity indices corresponding to the set of emails that the member was a secondary receiver, and sums the similarity indices corresponding to the set of emails that the member was an auxiliary receiver.

Meeting scheduler program 110 sums a set of scheduler scores with a set of participant scores using a weighted sum, both corresponding to a set of unique members (S310). The resulting weighted sum performed by meeting scheduler program 110 is called a criticality score, wherein the sum weights are determined by a scheduler. For example, for a single member, the criticality score is summed using the formula reproduced below:

$$C = {W}_{S} * S + {W}_{P} * P \qquad Formula 11$$

where C is the criticality score corresponding to a member, S and P are the scheduler score and participant score respectively, and W_{S} and Wₚ are the respective score weights for the scheduler score and the participant score.

In a further embodiment, meeting scheduler program 110 sums a set of scheduler scores, a set of participant scores, a set of sender scores, and a set of receiver scores. The resulting weighted sum performed by meeting scheduler program 110 is called a criticality score, wherein the sum weights are determined by a scheduler. For example, for a single member, the criticality score is summed using the formula reproduced below:

$$C = {W}_{S} * S + {W}_{P} * P + {W}_{Send} * Send + {W}_{Rec} * Rec \qquad Formula 12$$

where C is the criticality score corresponding to a member, S and P are the scheduler score and participant score respectively, Send and Rec are the sender score and receiver score respectively, and W_{S}, Wₚ, W_{Send}, W_{Rec} are the respective score weights for the scheduler score, the participant score, the sender score, and the receiver score.

In a further embodiment, meeting scheduling program 110 sums a set of scheduler scores, a set of primary participant scores, a set of secondary participant scores, a set of auxiliary participant scores, a set of sender scores, a set of primary receiver scores, a set of secondary receiver scores, a set of auxiliary receiver scores, all corresponding to a set of unique members. The resulting weighted sum performed by meeting scheduler program 110 is called a criticality score, wherein the sum weights are determined by a scheduler.

FIG. 4 depicts a block diagram of components of computer system 400, which is representative of the computer systems of within scheduling environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Server computer 102 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Meeting scheduler program 110 may be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Meeting scheduler program 110 may be downloaded to persistent storage 408 through communications unit 410.

I/O interface(s) 412 allows for input and output of data with other devices that may be connected to server computer 102. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., Meeting scheduler program 110, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving a set of meeting parameters for a meeting that include a set of members of the meeting, a subject of the meeting, and content for discussion in the meeting;
calculating a level of criticality and a level of flexibility for each unavailable member of the set of members of the meeting, wherein:
calculating a level of criticality for each unavailable member of the meeting comprises:
acquiring a set of meeting history and a set of electronic message history associated with the set of members of the meeting,
calculating a set of similarity scores utilizing the set of meeting parameters and the acquired set of meeting history and the acquired set of electronic message history by determining a similarity index utilizing a weighted cosine distance calculation for each of the set of meeting parameters,
calculating a set of similarity indices by combining the set of similarity scores, and
calculating a criticality score by summing the set of calculated similarity indices for the set of unavailable members of the meeting, and wherein
calculating a level of flexibility for each unavailable member of the set of members of the meeting comprises:
acquiring a criticality score of a conflicting meeting associated with an unavailable member of the set of members of the meeting, and
dividing a predetermined constant, by the acquired criticality score of the conflicting meeting;
combining the level of criticality and the level of flexibility for each unavailable member and mapping the combined level of criticality and the level of flexibility to respective time slots in a set of time slots specified by the meeting parameters, wherein combining the level of criticality and the level of flexibility for each unavailable member to a set of time slots specified by the meeting parameters comprises:
mapping the level of criticality and the level of flexibility for each unavailable member to a set of time slots specified by the meeting parameters,
summing the level of criticality for unavailable members of the set of members of the meeting,
summing the level of flexibility for unavailable members of the set of members of the meeting, and
subtracting the summed level of flexibility from the summed level of criticality;
identifying candidate meeting times based, at least in part, on the combined level of criticality and flexibility for each unavailable member;
receiving an indication to generate a list of recommended participants that are not specified as recipients of an electronic message;
responsive to receiving an indication to generate a list of recommended participants that are not specified as recipients of an electronic message, calculating a level of criticality for a set of participants that are not specified as recipients of the electronic message; and
populating a list of participants for the electronic message based on the calculated level of criticality.
